(19) United States
(12) Patent Application Publication
(10) Pub. No.: US 2006/0238286 A1
(43) Pub. Date: Oct. 26, 2006

(54) Carrier device for magnetizable substrate

(76) Inventors: Ralf Henn, Gomaringen (DE); Armin Scharping, Metzingen (DE)

Correspondence Address: KENYON & KENYON LLP, ONE BROADWAY, NEW YORK, NY, 10004, US

(21) Appl. No.: 10/568,137

(22) PCT Filed: Jul. 7, 2004
(86) PCT No.: PCT/DE04/01448

§ 371 Date: Feb. 8, 2006

(30) Foreign Application Priority Data
Aug. 11, 2003 (DE) 103 36 745.4

(51) Int. Cl. H01F 7/20

(52) U.S. Cl. 335/285

(57) ABSTRACT

A carrier device for magnetizable substrates, such as stainless steel substrates, which is suitable for processing thin-film substrates in particular. The carrier device includes at least one magnetized base element having at least one receptacle for a substrate.

### FIELD OF THE INVENTION

The present invention relates to a carrier device for magnetizable substrates, in particular for thin-film processing of the substrates.

### BACKGROUND INFORMATION

Sensor elements for greatly varying applications may be manufactured from stainless steel substrates by applying functional layers and structuring them. Thus, for example, sensor elements for piezoresistive high-pressure sensors are manufactured from stainless steel substrates having molded-in diaphragms. High-pressure sensors of this type are used in numerous systems in motor vehicles, for example, in gasoline direct injection, in common-rail diesel direct injection, in electronic stability programs, and in hydraulic braking systems.

The thin-film system of such a piezoresistive high-pressure sensor includes an insulation layer, usually made of SiOₓ, which is located directly on the steel diaphragm. Four piezoresistive strain gauges, made of NiCr, NiCrSi, or doped polysilicon, are positioned on the insulation layer. These form a Wheatstone measuring bridge, which is extremely sensitive to the slightest changes in the resistance of the individual strain gauges. The strain gauges are contacted via a special contact layer and/or a corresponding layer system, such as NiCr/Pd/Au or Ni. The entire thin-film system is protected from external influences by a passivation layer, usually a SiₓN_{y} layer. In this case, complete covering of the actual measuring bridge is essential in order to ensure interference-free operation of the sensor element. Typically, only the contact surfaces of the sensor element are not passivated.

Methods such as lithographic structuring, laser structuring, and deposition using shadow masks are typically used for structuring the piezoresistive layer, the contact layer system, and the passivation layer. Since the individual layers of the thin-film system are to be positioned very precisely in relation to one another, exact positioning and orientation of the individual substrates must be ensured during the entire manufacturing process.

Stainless steel substrates are typically provided as individual substrates but are usually processed in groups for reasons of costs. For this purpose, the substrates are normally positioned in a workpiece carrier. Such a workpiece carrier system for receiving individual substrates, which is suitable for mass production in particular, is described in German Patent Application No. 199 34 114. The conventional workpiece carrier system includes a base element in which receptacles for the substrates are implemented. The substrates remain in this base element during the entire manufacturing process and are secured there with the aid of a system of cover, pressure, and spring elements. The conventional workpiece carrier system includes multiple different cover elements, which are each designed for a special process step and may be replaced in the course of the processing. Shifting of the substrates in the receptacles of the base element may occur in this case, since typically a certain play must be maintained in order to be able to insert the individual substrates into the base element. These shifts result in a significant mask offset.

The individual sensor elements are positioned in the base element of the conventional workpiece carrier system via a mechanical guide in the form of complementary positioning elements, which are implemented in the area of the receptacles of the base element and, in addition, are provided in the contour of the substrates. These positioning elements also prevent distortions of the substrates between the individual method steps and during replacement of the cover elements. Exact positioning of the substrates in the base element may only be ensured here, however, if both the receptacles of the base element and the external contour of the substrates fulfill high tolerance requirements. In addition, the positioning elements make miniaturizing the sensor elements and increasing the packing density in mass production more difficult.

### SUMMARY

The present invention relates to a carrier device for magnetizable substrates, such as stainless steel substrates, which is suitable for processing thin-film substrates in particular, since it allows a very small mask offset between the individual structured planes with minimal tolerance requirements on the external contour of the substrates. In this way, the overall size of the components to be manufactured may be reduced and the packing density during manufacturing may be increased.

In accordance with an example embodiment of the present invention, the carrier device includes at least one magnetized base element having at least one receptacle for a substrate.

According to an example embodiment of the present invention, the magnetizability of the substrate material may be used for securing the substrates during the manufacturing process if the base element of the carrier device has magnetic properties. The magnetic effect of the base element holds the substrate in the receptacle even if there is mechanical play between receptacle and substrate. In this case, no additional distortion protection for the substrate is necessary. Therefore, corresponding features, which take up space, do not have to be provided in the area of the receptacles in the base element or on the substrates. This favors both the miniaturization of the components to be manufactured and also an increase of the packing density of substrates on the carrier device during manufacturing. In addition, the requirements for the external contour of the substrates, in particular the processing precision, are thus also reduced, which has a favorable effect on the manufacturing costs. The external contour of the substrates may even be varied within certain limits without the base element of the carrier device having to be adapted. Accordingly, components of different types may be manufactured using the carrier device according to the present invention.

In principle, there are various possibilities for implementing the carrier device according to the present invention and, in particular, for implementing the base element. In an advantageous variation, a planar, magnetized base metal sheet is used as the base element. Receptacles for the substrates may be implemented very easily in such a base metal sheet, for example, in the form of drilled holes or stamped holes, whose shape and dimensions are tailored to the contours of the substrates. In addition, a base metal sheet may advantageously be used as the substrate carrier within the scope of an automated manufacturing process and may be provided with corresponding handling features. In regard to the greatest possible packing density of the substrates during the manufacturing process, it may be advantageous if a grid system of receptacles for the substrates is implemented in the base metal sheet.

The substrates to be processed frequently have a peripheral collar, which is used for positioning in the base element of the carrier device according to the present invention. The receptacles in the base element are then advantageously dimensioned in such a way that the collars of the substrates are seated in the edge region of the receptacles. In regard to good media transparency of the carrier device according to the present invention, it is advantageous in this case if the shape and the dimensions of the receptacles are selected so that the collars of a substrate rest only partially on the base element, i.e., on the edge of a receptacle.

As already noted, a carrier device according to the present invention may include a magnetized base element, which is provided with receptacles for the substrates. In an advantageous embodiment of the present invention, which is suitable for thin-film processing in particular, the base element is made of Sm₄Co₁₇, so that it withstands processing temperatures of up to 350° C. unharmed. The base element may also, however, be made from multiple materials in order to improve the media resistance, the electrical linkage of the substrates, or the reusability, for example. The base element may be provided with a suitable coating for this purpose, for example, and only include a magnetic core. The base element may also itself be manufactured from a paramagnetic or diamagnetic material, in which ferromagnetic elements are embedded.

In an advantageous embodiment of the present invention, in addition to the base element, the carrier device may also include at least one cover element which is designed for at least one method step within the framework of the processing. One or more cover elements may be placed from above and/or below on the populated base element. At the same time, one or even more of these cover elements may also function as a mask for photolithography, laser structuring, layer depositions, or shadow mask depositions, for example. However, these may also be used for selective treatment of the substrate surface in wet processes. For this purpose, these cover elements may be provided with through openings which ensure high media transparency. Cover elements of this type may be implemented easily in the form of sheets, each sheet being provided with suitably shaped passages, drilled holes, and depressions in accordance with its function.

### BRIEF DESCRIPTION OF THE DRAWINGS

As already explained in detail above, there are various possibilities for advantageously implementing and refining the present invention. The following provides a description of an exemplary embodiment of the present invention.

FIG. 1 shows a sectional view of the base element of a carrier device according to an example embodiment of the present invention having inserted substrates.

FIG. 2 shows the system illustrated in FIG. 1 having a cover element which may be designed for a wet process or a layer deposition.

FIG. 3 shows the top view of a cover element which may be used for cleaning purposes.

FIG. 4 shows the top view of a cover element which is designed for a layer deposition.

FIG. 5 shows the system illustrated in FIG. 1 having a system of cover elements which is designed for, e.g., a shadow mask deposition.

### DETAILED DESCRIPTION OF EXAMPLE EMBODIMENTS

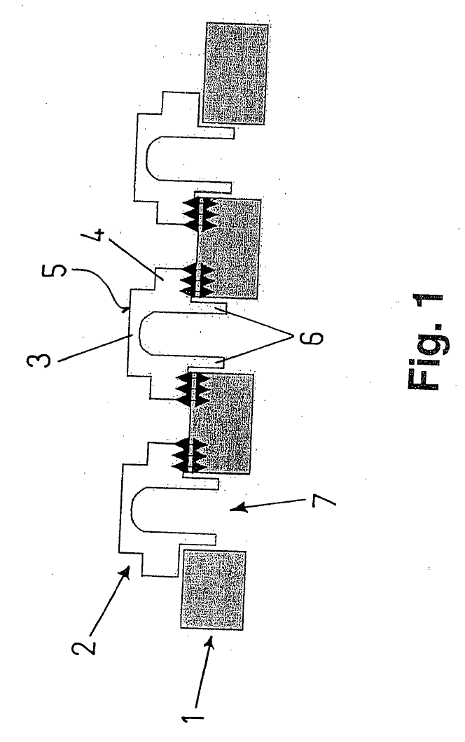

FIG. 1 illustrates base element 1 of a carrier device according to an example embodiment of the present invention for magnetizable substrates 2, from which sensor elements for piezoresistive high-pressure sensors are manufactured.

In the exemplary embodiment of the present invention shown here, these are stainless steel substrates 2, in each of which a diaphragm 3 is implemented. Rotationally-symmetric individual substrates 2 are provided with a peripheral collar 4. Diaphragm 3 is implemented in substrate surface 5 above collar 4. Substrate foot 6 is located below collar 4. A thin-film system is to be applied to substrate surface 5, through which the mechanical deformations of diaphragm 3 are to be converted into electrical signals. For this purpose, substrate surface 5 is first cleaned before an insulation layer is produced on substrate surface 5 in a PECVD (plasma-enhanced chemical vapor deposition) method, for example. Subsequently, a piezoresistive layer is deposited by sputtering, for example, from which four resistors are then structured through photolithography or laser structuring, which form a Wheatstone bridge. These resistors are contacted via a contact layer system, which is produced by sputtering, possibly shadow masks, or even structuring in a photo process. Finally, a passivation layer must also be deposited, which may again be performed in a PECVD method and possibly through shadow masks.

Receptacles 7 for substrates 2 are implemented in base element 1. According to an example embodiment of the present invention, base element 1 is at least partially made of a magnetized material, so that substrates 2 are held in base element 1 and fixed in receptacles 7 solely because of the magnetic interaction, which is indicated by the double arrows in the figures.

A planar base metal sheet made of Sm₄Co₁₇ is used as base element 1 in the exemplary embodiment shown here, so that it withstands the temperatures typically occurring in a thin-film method. Receptacles 7 for substrates 1 are implemented in the form of drilled holes in base metal sheet 1, the diameter of drilled holes 7 being selected in such a way that rotationally-symmetric substrates 2 may be inserted with substrate foot 6 in drilled holes 7 and then have collar 4 seated on base metal sheet 1. Together with the tolerance of the distance from the lower edge of collar 4 to substrate surface 5, the flatness of base metal sheet 1 determines the plane of exposure in a photo processing step, for example, so that the manufacturing quality is also a function of the flatness of base metal sheet 1. Drilled holes 6 are positioned in a hexagonal grid here in order to achieve the highest possible packing density. To increase the media transparency, the receptacles for the substrates may also have a shape deviating from the circular shape, as long as the collars of the substrates rest at least partially on the base metal sheet. In addition to illustrated receptacles 7 for substrates 2, base metal sheet 1 also includes handling features not shown here, such as guide pins, receptacle and drainage openings, etc., which support automated processing.

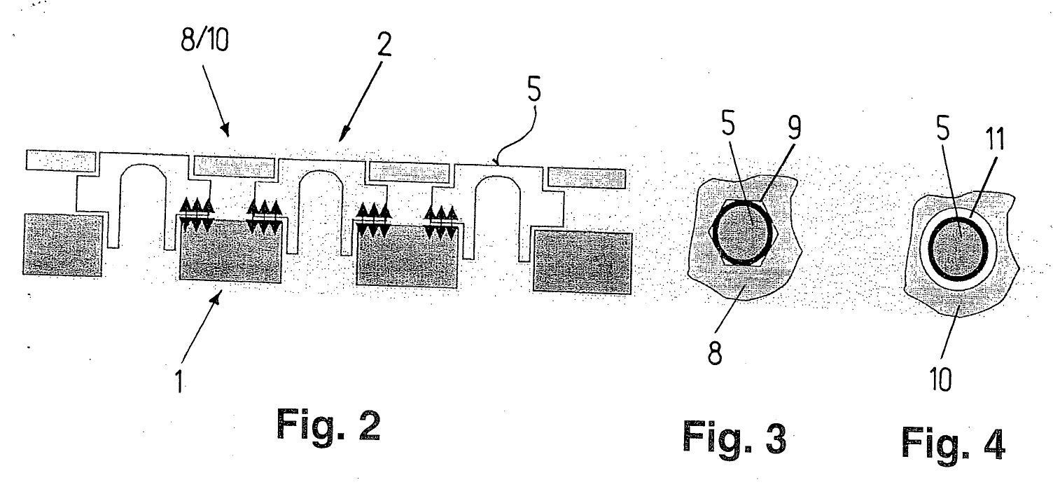

Substrates 2 remain in base metal sheet 1 during the entire course of the thin-film processing. Process-specific cover elements are placed on populated base metal sheet 1 for the individual process steps. A cover element 8 and/or 10 is shown in FIG. 2, which is implemented in the form of a cover sheet.

Such a cover sheet 8, which is designed particularly for wet processes, is illustrated in FIG. 3. It is provided with hexagonal stamped holes 9, which are positioned corresponding to the drilled hole grid in base metal sheet 1 and are dimensioned in such a way that cover sheet 8 rests on collars 4 of substrates 2. In addition, the thickness of cover sheet 8 is tailored to the dimensions of substrates 2, so that cover sheet 8 terminates nearly flush with substrate surface 5. Hexagonal stamped holes 9 in cover sheet 8 help ensure high media transparency, which is generally considered to be essential in wet processes and for cleaning processes in particular. Cover sheet 8 is generally used for mechanical stabilization of the magnetic attachment of substrates 2 in base metal sheet 1, but may also be used because of electrochemical effects. Depending on the type of the wet process, its use may also be dispensed with.

The carrier device according to an example embodiment of the present invention may also include a cover element 10 which is designed for layer depositions. The use of a cover sheet 10 which, precisely like cover element 8, rests on collars 4 of substrates 2 and whose height terminates as flush as possible with substrate surface 5, also suggests itself for this purpose, since the flattest possible coating surface is to be implemented for PECVD processes in particular. In contrast to stamped holes 9 in cover sheet 8, however, cover sheet 10 is provided with drilled holes 11 which enclose substrate surface 5 to be coated of substrates 2 as closely as possible, which is illustrated in FIG. 4.

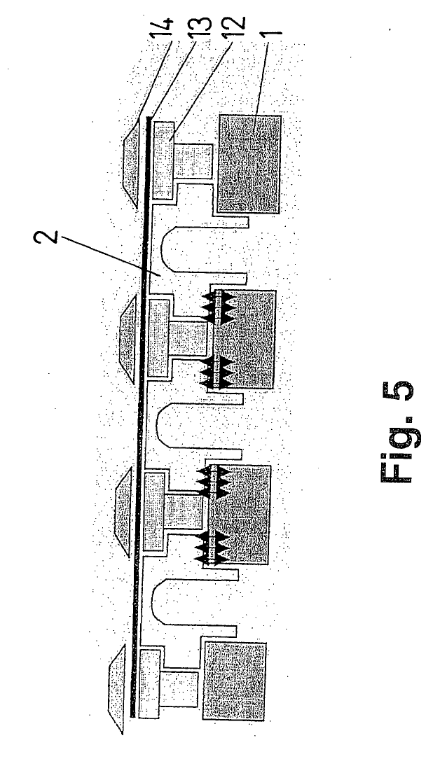

A carrier device according to the present invention having a system of cover elements, which is designed for shadow mask depositions, is illustrated in FIG. 5. For shadow mask depositions, a spacer sheet 12 is first laid on populated base metal sheet 1, which is slightly, i.e., approximately 10 μm, thinner than the distance between the lower edge of collar 4 and substrate surface 5. Spacer sheet 12 is structured so that it rests on collars 4 of substrates 2 and is oriented in relation to base metal sheet 1. Shadow mask 13 is laid on spacer sheet 12 and also oriented in relation to base metal sheet 1 with the aid of guide pins, for example, which are incorporated into spacer sheet 12 but are not shown here. A pressure sheet 14 is laid on shadow mask 13, using which shadow mask 13 is pressed against substrate surface 5. The shadow mask assembly described above is screwed together. Alternatively, a magnetized pressure sheet 14 may also be used in order to press shadow mask 13 against substrate surface 5 or the shadow mask itself is magnetized and is drawn to the substrate surface. In addition to the flatness of base metal sheet 1 and spacer sheet 12, a low height tolerance of substrates 2, which relates to the distance of the lower edge of collar 4 to substrate surface 5, may be important in order to achieve comparable conditions in the shadow mask deposition for all substrates 2. The tolerances are to be defined correspondingly.

Other method steps which are performed within the scope of thin-film processing, such as balancing, measurement, exposure, laser structuring, etc., may be performed either using only magnetized base metal sheet 1 or using one of the cover elements described above.

1-11. (canceled)

12. A carrier device for magnetizable substrates, comprising:
at least one magnetized base element, which has at least one receptacle for a substrate.

13. The carrier device as recited in claim 12, wherein the substrate is a thin film substrate.

14. The carrier device as recited in claim 12, wherein the base element includes a magnetized base metal sheet.

15. The carrier device as recited in claim 14, wherein the receptacle for the substrate is one of a drilled hole, a stamped hole, or a passage with or without depressions in the base metal sheet, a shape and dimensions of the receptacle being tailored to the contour of the substrate.

16. The carrier device as recited in claim 15, wherein the base metal sheet has multiple at least one of: i) drilled holes, ii) stamped holes, and iii) passages with or without depressions, which are positioned in a grid.

17. The carrier device as recited in claim 12, wherein the substrate has a peripheral collar and a shape and dimensions of the receptacle being such that the collar of the substrate rests only partially on the base element.

18. The carrier device as recited in claim 12, wherein the substrate has a collar, and a shape and dimension of the receptable being such that the collar of the substrate rests only on an edge of the receptacle.

19. The carrier device as recited in claim 12, wherein the base element is at least partially made of Sm₄Co₁₇.

20. The corner device as recited in claim 12, wherein the base element is at least partially made of a ferromagnetic material.

21. The carrier device as recited in claim 12, further comprising at least one cover element configured to be situated on the base element from at least one of above and below, relative to the base element, the at least one cover being used during a processing of substrate.

22. The carrier device as recited in claim 21, wherein the at least one cover element is configured for a wet process, the at least one cover element having through openings or high media transparency.

23. The carrier device as recited in claim 21, wherein the at least one cover element is configured for layer deposition.

24. The carrier device as recited in claim 21, wherein the at least one cover element is configured for shadow mask deposition.

25. The carrier device as recited in claim 21, wherein the at least one cover element is implemented in a form of sheets, each sheet being provided with at least one of: i) drilled holes, ii) stamped holes, and iii) passages with or without depressions.
